(19) United States
(12) Patent Application Publication
(10) Pub. No.: US 2022/0290701 A1
(43) Pub. Date: Sep. 15, 2022

(54) STRUCTURAL SUBSURFACE MATERIAL FOR TURBULENT FLOW CONTROL

(71) Applicant: The Reg. of the Univ. of Colorado, a body corp., Denver, CO (US)

(72) Inventors: Mahmoud Hussein, Boulder, CO (US); Mary W. Bastawrous, Boulder, CO (US); Sedat Biringen, Boulder, CO (US)

(21) Appl. No.: 17/753,235

(22) PCT Filed: Aug. 24, 2020
(86) PCT No.: PCT/US2020/047695

§ 371 Date: Feb. 24, 2022

Related U.S. Application Data
(60) Provisional application No. 62/891,325, filed on Aug. 24, 2019.
(60) Provisional application No. 62/891,321, filed on Aug. 24, 2019.

(51) Int. Cl. F15D 1/00; B32B 15/08; B32B 15/20

(52) U.S. Cl. CPC F15D 1/006; B32B 15/08; B32B 15/20

(57) ABSTRACT

Structural subsurface materials and subsurface structures adapted for interacting with a flow are provided. In one example, a structural subsurface material or subsurface structure is provided for use in interacting with a fluid or solid flow. The structural subsurface material comprises a flow interface surface adapted to be disposed adjacent a flow and a subsurface feature comprising a structural material. The subsurface feature extends away from the flow interface surface. The subsurface feature alters an effective structural compliance of the flow interface surface relative to the flow such that the flow experiences an alteration in surface skin-friction drag and/or in kinetic energy in a turbulent flow. In other implementations, methods of controlling a flow with a structural subsurface material or a subsurface structure are provided. Further, methods of designing structural subsurface materials and subsurface structures for interacting with a flow are also provided.

### CROSS-REFERENCE TO RELATED APPLICATIONS

This application claims the benefit of U.S. provisional application No. 62/891,325 entitled “STRUCTURAL SUBSURFACE MATERIAL FOR TURBULENT FLOW CONTROL” and filed on 24 Aug. 2019, which is hereby incorporated by reference as though fully set forth herein.

### BACKGROUND

U.S. patent application Ser. No. 14/811,801 filed on Jul. 28, 2015 (the '801 application) and Ser. No. 15/636,639 filed on Jun. 29, 2017 (the '639 application) and PCT patent application nos. PCT/US15/42545 filed on Jul. 28, 2015 and PCT/US18/40114 filed on Jun. 28, 2018 and disclosed structural subsurface materials disposed adjacent a flow surface and extending away from the flow surface in a direction away from the flow (e.g., at least generally perpendicular to the flow surface). In some instances, the structural subsurface material(s) were designed using concepts from phononics to control the flow. In other instances, design criteria based on a phononic metric for the subsurface phononic material and a performance criterion based on a reduction in kinetic energy in the flow and/or a reduction of drag along the surface were disclosed. Each of the listed applications are incorporated by reference herein in their entirety for all they teach and suggest.

### SUMMARY

Structural subsurface material(s) and subsurface structures provided herein may comprise periodic materials, homogeneous materials, lattice materials, composite materials, or any other type of structural material such as metal, rubber, polymer, ceramic, wood, or the like. The concept comprises the introduction of an elastic medium (the structural subsurface material), located at one or more points or regions of interest along a solid flow surface, and extending away from the solid flow surface, e.g., perpendicular to the surface, at an angle to the surface, along the surface or any combination thereof.

In one particular implementation, for example, a structural subsurface material is provided for use in interacting with a fluid or solid flow. The structural subsurface material comprises a flow interface surface adapted to be disposed adjacent a flow and a subsurface feature comprising a structural material. The subsurface feature extends away from the flow interface surface. The subsurface feature alters an effective structural compliance of the flow interface surface relative to the flow such that the flow experiences an alteration in surface skin-friction drag and/or in kinetic energy in a turbulent flow.

In another implementation, a method of designing a subsurface structure for use in interacting with a fluid or solid flow is provided. The method comprises designing a subsurface structure to interact with a turbulent flow; performing an effective structural compliance analysis on the subsurface structure with or without an interfacing surface; and altering the subsurface structure based on the compliance analysis.

In yet another implementation, a method of interacting with a flow is provided. In this implementation the method comprises providing an interface surface juxtaposed the flow; receiving a pressure associated with at least one wave having at least one frequency in a flow exerted on the interface surface; receiving the at least one wave via a subsurface structure extending from the interface surface; altering a phase of the at least one wave via the subsurface structure; and vibrating the interface surface at a frequency, phase and amplitude in response to the altered phase of the at least one wave. The subsurface structure alters an effective structural compliance of the flow interface surface relative to the flow such that the flow experiences an alteration in surface skin-friction drag and/or in kinetic energy in a turbulent flow.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic diagram of a flow channel with a subsurface structure incorporated into the flow channel. The subsurface structure can include a surface that functions as an interface surface with a flow in the channel or may be disposed adjacent or juxtaposed to a flexible material that serves as an interface surface and is adapted to move in response to a pressure exerted on the flexible material the surface by a fluid flowing in the flow channel.

FIG. 2 is a schematic diagram showing different example configurations of periodic materials that may be used as a structural subsurface material in some implementations.

FIG. 3 depicts a plurality of example configurations of phononic crystals and locally resonant metamaterials that may be used to form a subsurface structure.

FIG. 4 is a schematic drawing depicting an example configuration of a two-dimensional elastic metamaterial with one-dimensional locally resonant oscillators extending from a base material.

FIG. 5 is a schematic drawing showing a plurality of example configurations of one-dimensional subsurface structures, each have a different composition and ordering of two materials, and thus each giving a specific effective structural compliance.

FIG. 6 is a schematic drawing showing other example configurations of two-dimensional subsurface structures comprising embedded resonant oscillators—these configurations may be used to form a subsurface structure where the plates, where appropriate, may be oriented either in parallel or perpendicular or at an angle to the surface (and to the flow).

FIG. 7 depicts other example configurations of two-dimensional subsurface structures with two-dimensional locally resonant oscillators extending from a base material.

FIG. 8 is a schematic drawing showing other example configurations of three-dimensional subsurface structures comprising embedded resonant oscillators.

FIG. 9 is a graph showing kinetic energy change versus structural compliance of several example designs of a structural subsurface material as shown in FIG. 5 for a turbulent flow.

FIGS. 10 and 11 are schematic drawings showing examples of structural subsurface materials that include one or more voids disposed within the structural subsurface material to further reduce the effective stiffness of the structural subsurface material (e.g., in a direction perpendicular to the flow/flow surface), and an improved performance of the structural subsurface material at reducing surface friction drag from a turbulent flow.

FIG. 12 is a graph showing kinetic energy change of a turbulent wave versus length, x. The results are for the layered structural subsurfaces shown in FIG. 5 and correspond to the results presented in FIG. 9 showing that the higher the overall compliance of the structural surface the stronger the reduction in the kinetic energy in the turbulent flow particularly near the area where the structural subsurface is applied.

FIG. 13 shows side and top views of an example configuration of a structural subsurface material disposed adjacent to a flow. It can be seen in this example that the structural subsurface can be disposed in different locations along the surface and do not need to be contiguous.

FIG. 14 shows side and top views of another example configuration of a structural subsurface material disposed adjacent to a flow.

FIG. 15 is a schematic diagram of a distributed load applied to a sublattice designed to provide a desired effective structural compliance.

FIG. 16 is a schematic diagram of an example sublattice structure, such as shown in FIG. 15, disposed adjacent or juxtaposed to a flow.

FIG. 17 is schematic diagram of another example sublattice structure, such as shown in FIGS. 15 and 16, disposed adjacent or juxtaposed to a flow.

FIG. 18 is schematic diagram of another example sublattice structure, such as shown in FIGS. 15 and 16, disposed adjacent or juxtaposed to a flow.

FIG. 19 provides schematic diagrams of a point load and a distributed load applied to a sublattice structure, such as those shown in FIGS. 15-18.

FIG. 20 is a schematic drawing showing a prototype turbulent channel rig that can be used for testing the performance of an example structural subsurface material such as the example lattice substructure (labeled here as SSub) shown for the purpose of turbulent flow increase or decrease in intensity of turbulence.

### DETAILED DESCRIPTION

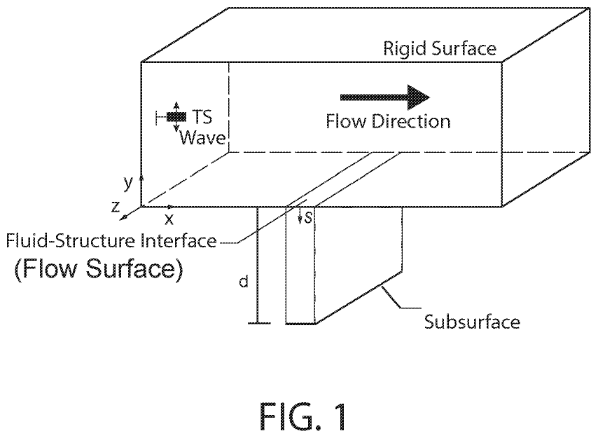

Structural subsurface material(s) provided herein may comprise periodic materials, homogeneous materials, lattice materials, composite materials, or any other type of structural material such as metal, rubber, polymer, ceramic, wood, or the like. The concept comprises the introduction of an elastic medium (the structural subsurface material), located at one or more points or regions of interest along a solid flow surface, and extending away from the solid flow surface, e.g., perpendicular to the surface, at an angle to the surface, along the surface or any combination thereof. One example implementation is shown in FIG. 1, in which a segment of a surface (e.g., a bottom surface) of a flow channel with otherwise all-rigid walls is replaced with a one-dimensional (1D) elastic structural subsurface material extending away from the flow surface. The structural subsurface material shown in FIG. 1 may be any structural subsurface material such that the entire structural subsurface material has an overall structural compliance that can be characterized and correlated with the aforementioned performance metric in the flow, such as drag reduction on the surface, and is not limited to the phononic crystal or locally resonant metamaterials described in the above-referenced '801 and '639 applications.

Reduction in turbulence can be measured in the reduction of kinetic energy in the flow and/or reduction of surface drag along the flow surface at the interface of the flow surface and the structural subsurface material. The flow in this context comprises the motion of a fluid medium of gas or liquid, or a gas-liquid mixture, or a gas-liquid-solid mixture, or a liquid-solid mixture, or a gas-solid mixture. The concept comprising interaction with the velocity and/or pressure fields of a flow can be used to control turbulent flows in order to reduce local skin friction and hence to reduce drag on surfaces and bodies that move in a fluid medium of gas or liquid, a gas-liquid mixture, a gas-liquid-solid mixture, a liquid-solid mixture or a gas-solid mixture.

One example methodology for designing a structural subsurface material for reducing turbulence is as follows. First, a unit cell of the structural subsurface material is designed and/or optimized to interact with a turbulent flow. Then, a steady-state frequency response analysis is conducted on a model representing a finite structure composed of one or more unit cells of the type designed above. The unit cells may be laid out in the direction perpendicular, or parallel, or both, to the surface (and flow). The unit cell and possibly the end design and boundary conditions of the structure are then altered until the interaction with the flow operates as desired. A performance metric is then used to evaluate the predicted performance of the structural subsurface material as explained in more detail below. The process can be repeated until the predicted performance metric meets one or more design criteria for reducing kinetic energy in a turbulent flow (e.g., for reducing skin-friction drag) or for increasing kinetic energy in a turbulent flow (e.g., for combustion or mixing applications).

In one implementation, for example, an effective structural compliance of a subsurface structure can be defined as a quantity that describes total deformation of the subsurface structure in a direction perpendicular to the flow divided by the total applied resultant force acting from the flow onto the subsurface structure through the fluid-structure interface. For example, if the structural subsurface has n layers laid out perpendicular to the flow, then the total deformation of the subsurface in the direction of the flow will be

$$Δ {l}_{tot} = Δ {l}_{1} + Δ {l}_{2} + … + Δ {l}_{i} + … + Δ {l}_{n} = \frac{F {l}_{1}}{{E}_{1} A} + \frac{F {l}_{2}}{{E}_{2} A} + … \frac{F {l}_{i}}{{E}_{i} A} … + \frac{F {l}_{n}}{{E}_{n} A} ,$$

where Δlᵢ is the deformation of layer i, F is the total resultant applied force from the flow onto the structure in the direction perpendicular to the flow, lᵢ is the length of the layer in the direction perpendicular to the flow, Eᵢ is the Young's modulus of the material of the layer, and Aᵢ is the cross-sectional area of the layer in the direction perpendicular to the flow. It follows that the effective structural compliance of the subsurface structure for this case is

$${C}_{Eff} = \frac{Δ {l}_{t o t}}{F} = \frac{1}{A} ( \frac{{l}_{1}}{{E}_{1}} + \frac{{l}_{2}}{{E}_{2}} + … + \frac{{l}_{n}}{{E}_{n}} ) .$$

In another example methodology, a subsurface structure may be designed offline using a compliance criterion as described herein, and not need to be designed by iterations. One advantage of this approach is that the structural subsurface material can be fully designed without carrying out any coupled fluid-structure simulations (which tend to be computationally expensive). However, a fluid-structure simulation may be conducted as a verification, especially to ensure that the level of damping (material and structural) in the structural subsurface material is optimal and/or meets one or more design criteria.

In various embodiments, one or more subsurface structure elements may be used to control the overall structural compliance of a subsurface structure by selection of its material(s) and/or structural geometry and dimensions. In one embodiment, for example, a structural material may be distributed, such as but not limited to in a direction perpendicular to a solid flow surface, such that the overall structural compliance (opposite of stiffness) of the that structure results in a decrease in drag along the flow surface adjacent or juxtaposed to where the subsurface structure is applied. This effectively reduces negative effects of turbulence. Prior approaches place a thin “surface material” or a thin “coating” along the surface; these do not extend in a direction away from the flow surface (e.g., in the perpendicular direction from the flow surface) and therefore need to be overly compliant (i.e., like rubber) to reduce the drag. In embodiments provided herein, a subsurface material may comprise a relatively stiff material (like plastic) because the overall structural compliance need not be defined just by the type of material but by the fact that the subsurface material extends as a structure away from the flow surface. The longer the extension, the lower the stiffness (the higher the compliance) as felt by the flow. As described herein, the structural subsurface may comprise a number of different size, shape and location structural subsurface materials that may be adapted for different turbulent flow conditions.

### Implementation

Flow and Solid Surface Control

In some implementations, for example, structural subsurface materials can be used in applications, such as, but not limited to any air, sea and land vehicles, manned and unmanned (drones), water and wind turbine blades, propellers, fans, steam and gas turbines blades, among other applications, for the purposes of drag reduction, turbulence reduction, enhanced maneuverability, lift enhancement, heat transfer control (enhancement and/or reduction), noise control, vibration control, flutter avoidance, inducing surface movement in all three coordinate directions; separation delay, among others.

Fluids

Examples of fluids that may be used with structural subsurface materials such as described herein, include, but are not limited to, the following: all fluids, gases, liquids, single and multi-phase, mixtures, and the like. In one particular implementation, for example, air, water, oil, natural gas, sewage or other fluids may be used with structural subsurface materials. Fluids can exist at room temperature, lower than room temperature, higher than room temperature. Applications cover static fluids, incompressible fluids, subsonic, transonic, supersonic, hypersonic flow regimes; laminar, turbulent and transitional flow regimes; smooth surfaces, surfaces with surface roughness—appearing naturally and by transition; instability, transition and turbulence—instigated naturally, with acoustic excitations, with finite-size roughness elements of any shape, plant canopies, others; by-pass instabilities, transition and turbulence.

Flow control applications cover all flow fields. These include (but are not limited to) external and internal flows, and their various combination; all flow fields are included.

External flows: Flows over aircraft wings (passenger aircraft, fighter aircraft, tankers, military aircraft, all fixed wing aircraft, rotary wing aircraft, helicopters, vertical take-off aircraft, re-usable space vehicles, aircraft with jet engines, aircraft with propellers, ship-based Navy aircraft); flow control in wing-body junctions, over fuselages, in and around aircraft engine inlets, turbines, over turbine blades, blade passages, wind turbine blades; wings of any cross-section, symmetric, non-symmetric, with and without camber, all wing, airfoil and hydrofoil profiles (including NACA and NASA airfoils), delta wings, folding wings, retractable wings, wing appendages, high-lift devices. Flows around sea vehicles including ships (battleships, cruise ships, cargo ships-manned), tankers, carriers, racing boats, sailing boats, unmanned boats submarines (manned and unmanned), deep-sea vehicles, hovercrafts, jet skis, water boards, among others. Flows around wind turbine blades of any type and water and steam turbines of any type.

Internal flows (of any fluid, gas and/or liquid): Flows in pipes, open or closed (channels), of any cross-sectional shape, and length, and at any temperature, and of sudden or gradual expansion; pipes of circular, square, elliptic, rectangular, triangular shapes, of any material; pipes with surface heating and/or cooling, pump-driven, gravity driven, buoyancy-driven. Pump impellers, steam turbines, pump and turbine inlet and outlet passages, flows over their blades.

The applications further cover ships, ship hulls, ship propellers, passenger ships, cruise ships, military ships of all kinds, sizes and uses, ordinance deployed in air and sea faring military manned and/or unmanned vehicles, speed boats, race boats, sail boats of all kind, used for pleasure, transportation, cargo, racing. Snow vehicles, alpine and cross-country skis, snow boards, paddle boats, wind surfing boards, parachute (ski) surfing boards, swimsuits, skates, skateboards, water skiing boards.

Any solid surface that is made of any material may be used in the application of the concepts provided herein, including (but are not limited to) aluminum, plastic/polymer (all types), titanium, steel, copper, cement, rare earth; all materials (natural or synthetic) that are in contact with any fluid are included in the scope of the implementations described herein covering the wide range of applications mentioned in this document.

Structural Subsurface Material

A structural subsurface material may comprise periodic materials, homogeneous materials, lattice materials, composite materials or any other type of structural material such as metal, rubber, polymer, ceramic, wood, or the like. A structural subsurface material may comprise one or more variation or variation of geometric feature that may extend in a one-, two- or three-dimensional sense, and could comprise one, two or more constituent materials.

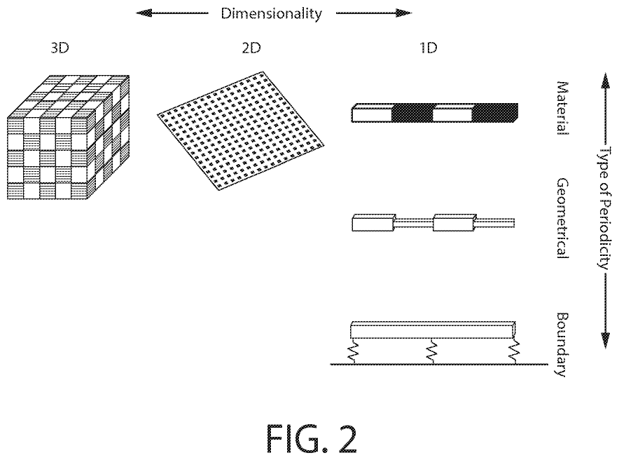

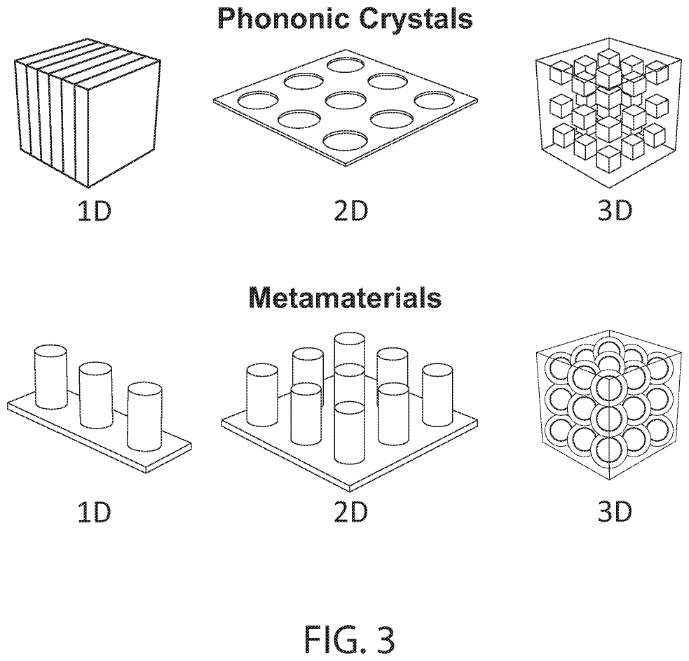

FIG. 2 demonstrates different example configurations of periodic materials that may be used as a structural subsurface material in some implementations. FIGS. 3-11 demonstrate different possible configurations of locally resonant metamaterials that may comprise the structural subsurface material. FIGS. 3-8 are described in detail in the following applications incorporated by reference herein: U.S. patent application Ser. No. 14/811,801 filed on Jul. 28, 2015 (the '801 application) and Ser. No. 15/636,639 filed on Jun. 29, 2017 (the '639 application) and PCT patent application nos. PCT/US15/42545 filed on Jul. 28, 2015 and PCT/US18/40114 filed on Jun. 28, 2018.

FIG. 3 depicts a plurality of example configurations of phononic crystals and locally resonant metamaterials that may be used to form a phononic subsurface. The various examples include one-dimensional (1D), two-dimensional (2), and three-dimensional (3D) example configurations.

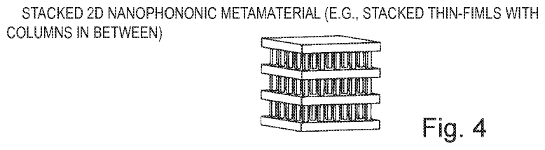

FIG. 4 depicts an example configuration of a two-dimensional elastic metamaterial with one-dimensional locally resonant oscillators extending from a base material. These configurations may be used to form a phononic subsurface where the plates, where appropriate, may be oriented either in parallel or perpendicular or at an angle to the surface (and to the flow). While FIG. 4 shows an example including three layers of pillared thin films stacked on top of each other, the number of layers of pillared thin films stacked could vary.

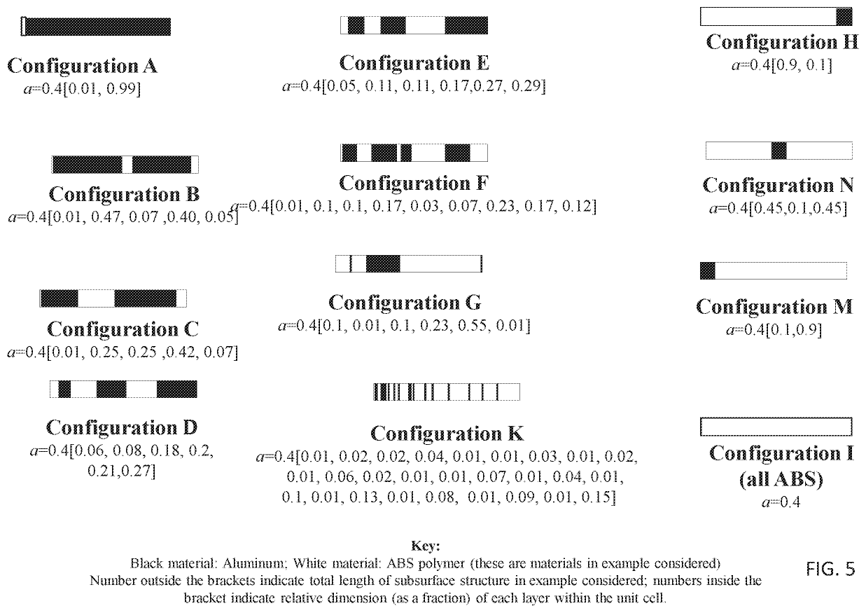

FIG. 5 depicts a plurality of example configurations of one-dimensional subsurface structures, each have a different composition and ordering of two materials, and thus each giving a specific effective structural compliance.

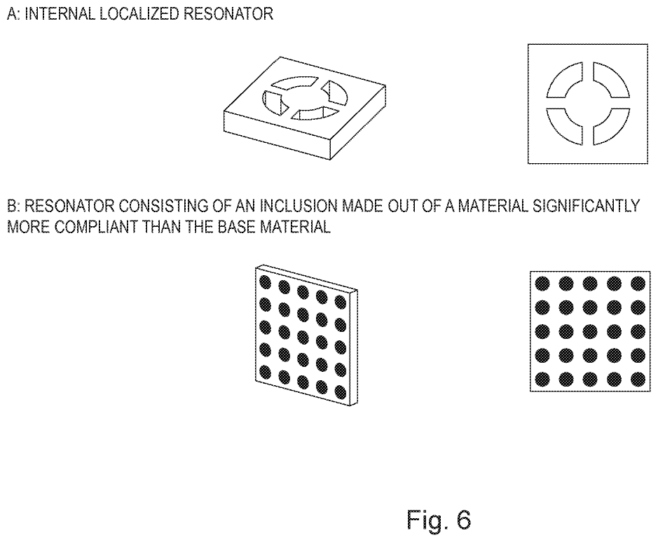

FIG. 6 shows other example configurations of two-dimensional subsurface structures comprising embedded resonant oscillators—these configurations may be used to form a subsurface structure where the plates, where appropriate, may be oriented either in parallel or perpendicular or at an angle to the surface (and to the flow).

FIG. 6 shows different perspective views of implementations of a generally two-dimensional plate including a bridged structure having a central cylinder supported by thin arms (e.g., beams). In this implementation, for example, the unit cell may be repeated to form a periodic or non-periodic array. The central cylinder (which could be of the same material as the main body of the thin film, or a heavier material) acts as a local oscillator/resonator in this configuration. Other shapes for oscillators/resonators in this configuration (e.g., square cylinder, sphere, others) may be employed, and the supporting arms also could have other shapes, number and orientations. This configuration concept could also be realized in the form of a 2D thick plate-like material with each oscillator/resonator taking the shape of a cylinder, or sphere or other shape. FIG. 6 also shows different perspective views of another implementation of a generally two-dimensional plate with a periodic array of circular inclusions comprising a highly compliant material (i.e., a material that is significantly less stiff than the material from which the main body of the thin film is made). In this particular implementation, for example, each inclusion of a compliant material in this configuration may act as an oscillator/resonator. Other shapes and sizes for the inclusions may also be adopted. The sites of the compliant inclusions may be ordered in a periodic fashion (as shown) or may be randomly distributed. Similarly, the size of each inclusion may be uniform or may vary in groups or vary randomly.

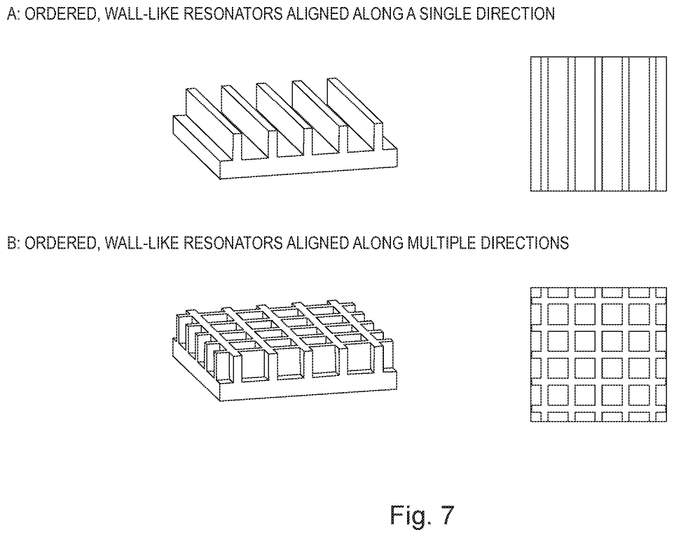

FIG. 7 depicts other example configurations of two-dimensional subsurface structures with two-dimensional locally resonant oscillators extending from a base material. These configurations may be used to form a subsurface structure where the plates, where appropriate, may be oriented either in parallel or perpendicular or at an angle to the surface (and to the flow). FIG. 7 shows different perspective views of another implementation of a generally two-dimensional (2D) plate including a one-dimensional (1D) periodic array of equal-sized walls disposed on a first surface of the plate (e.g., a top surface of the plate). In this particular implementation, each wall acts as an oscillator/resonator representing a 2D version of a pillar. The walls have a uniform cross section along the length, but other configurations could have a periodically or non-periodically varying cross-section along the length of the wall. Although walls are shown on a single side in FIG. 7, another implementation may have a similar configuration of walls but on two surfaces of a plate. FIG. 7 also shows different perspective views of yet another implementation of a generally two-dimensional (2D) plate including a two-dimensional (2D) periodic array of equal-sized or different sized walls disposed on a first surface of the plate (e.g., a top surface of the plate). In this particular implementation, each wall acts as an oscillator/resonator representing a 2D version of a pillar. Each wall has a uniform cross section along the length, but other configurations could have a periodically or non-periodically varying cross-section along the length of each wall. The thickness of the vertical walls could be different than the thickness of the horizontal walls. Although walls are shown on a single side in FIG. 7, another implementation may have a similar configuration of walls but on two surfaces of a plate.

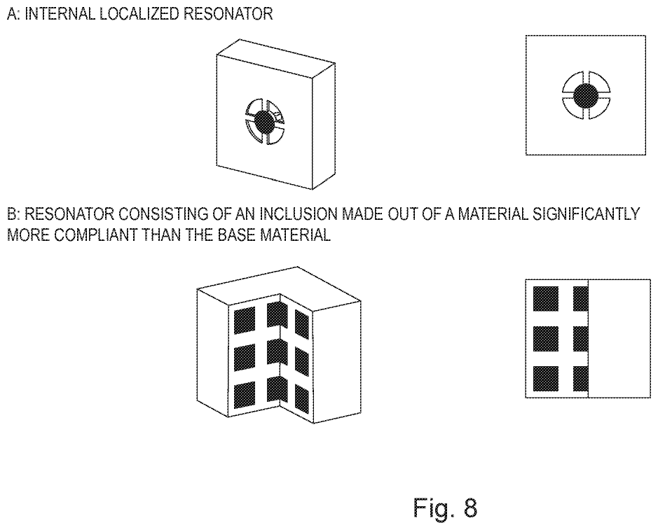

FIG. 8 depicts other example configurations of three-dimensional subsurface structures comprising embedded resonant oscillators. In various implementations, these configurations may be used to form a phononic subsurface where the periodic features may be oriented in any direction with respect to the surface (and the flow). FIG. 8 shows different perspective views of additional implementations of a 3D material configuration including a bridged structure having a central sphere supported by thin arms (e.g., beams). In this implementation, for example, the unit cell may be repeated to form a periodic or non-periodic array. The central sphere (which could be of the same material as the main body of the thin film, or a heavier material) acts as a local oscillator/resonator in this configuration. Other shapes for oscillators/resonators in this configuration (e.g., cubic sphere, cylinder, others) may be employed, and the supporting arms also could have other shapes, number and orientations. In analogy to the configuration shown in FIG. 8 (which is a 2D version), the sites of the local resonators may be ordered in a periodic fashion (as shown) or may be randomly distributed. FIG. 8 also shows a 3D material configuration with a periodic array of cubic inclusions comprising a highly complaint material (i.e., a material that is significantly less stiff than the material from which the main body is made). The compliant material in this configuration acts as an oscillator/resonator. Other shapes for the inclusions may be adopted. In analogy to the configuration shown in FIG. 6 (which is a 2D version of one of the implementations shown in FIG. 8), the sites of the compliant inclusions may be ordered in a periodic fashion (as shown) or may be randomly distributed. Similarly, the size of each inclusion may be uniform or may vary in groups or vary randomly.

In various implementations, structural subsurface materials are disposed in or adjacent to a solid flow surface that interacts with a fluid (i.e., liquid and/or gas and/or flowing solid) flow. As used herein, a flow surface or solid flow surface refers to a solid surface, such as a wall of the flow channel disposed adjacent to the flow. In one particular example of a structural subsurface material, periodic materials refer to periodic materials, such as phononic crystals, and/or locally resonant metamaterials. Phononic crystals, which are spatially periodic, include materials designed based on the Bragg scattering principle. Locally resonant metamaterials, which are not necessarily spatially periodic, include those that work on the principle of internal resonances and mode hybridization.

As described above, the concept comprises the introduction of an elastic medium (the structural subsurface material), located at one or more points or regions of interest along a flow surface, and extending away from the flow surface, e.g., perpendicular to the surface, at a non-perpendicular angle to the surface, along the surface or any combination thereof. One example implementation is shown in FIG. 1, in which a segment of a surface (e.g., a bottom surface) of a flow channel with otherwise all-rigid walls is replaced with a one-dimensional (1D) elastic structural subsurface material extending away from the flow surface. The structural subsurface material shown in FIG. 1 may be any structural subsurface material such that the entire structural subsurface material has an overall structural compliance that can be characterized and correlated with the aforementioned performance metric in the flow.

Further, the terms one-dimensional (1D), two-dimensional (2D) and three-dimensional (3D) are used herein to describe both the characteristics of various structural subsurface base material configurations as well as the shape, size, orientation, material composition and/or location/distribution of material/geometrical interfaces or local oscillators/resonators, such as in a locally resonant metamaterial. A base material, for example, may be described as a one-dimensional (1D) base material in the shape of a wire or rod, beam or column that extends, with the exception of other dimensions, in a generally single dimension. Similarly, a base material, such as a thin-film/membrane/sheet or plate-shaped base material may be described as a two-dimensional (2D) structure, with the exception of other dimensions, that extends in two dimensions. Also, a different base material, such as a bulk material, may be described as a three-dimensional (3D) base material. Similarly, local oscillators/resonators, such as pillars shown in FIG. 4 may also be described with respect to one, two- or three-dimensional structures as described below with reference to those figures.

In one implementation, local oscillators/resonators in the form of pillars or resonant inclusions are positioned periodically or non-periodically along one or both free surfaces of a plate base material.

In another implementation, multiple pillar local oscillators/resonators are used on one or both free surfaces of a base thin-film material with each including a unique (distinct) height and/or cross-sectional area (see, for example, FIGS. 2D and 2E). In this implementation, utilization of multiple pillars (above and/or below the thin film), each of which has a distinct geometrical dimension (in terms of the height and/or the cross-sectional area).

One example implementation is shown in FIG. 1 in which a one-dimensional (1D) elastic structural subsurface material extending along a depth away from a flow surface interface and the flow. The elastic structural subsurface material may replace a segment of a bottom surface of a flow channel with otherwise all-rigid walls or may be disposed adjacent to a flexible bottom surface (or portion thereof) of the flow channel. In this particular implementation, the flow channel comprises a plurality of walls, such as the four walls shown, and having a generally rectangular cross-section. In other implementations, the flow channel may comprise any shape such as having a generally circular, elliptical, square, polygon or other cross-section. The flow channel may also include varying dimensions, such as a narrowing or expanding flow channel.

In the implementation shown in FIG. 1, for example, a flow direction of a fluid flowing through the flow channel flows in a first direction as shown by the arrow. The flow channel includes a plurality of rigid surfaces defining the flow channel disposed within an inner boundary formed by the rigid surfaces. In various implementations, a flow surface adjacent to or juxtaposed to the subsurface structure may be replaced by one or more subsurface structure material (e.g., an elastic material of the overall subsurface structure) or the portion of the flow surface disposed adjacent to or juxtaposed to the subsurface structure may comprise a flexible material that may move in response to a pressure exerted on the surface by a fluid flowing in the flow channel.

In one implementation, for example, one or more locations the rigid surface is replaced by a one-dimensional (1D) elastic periodic material as shown in FIG. 1. In this implementation, the one-dimensional elastic periodic material includes a plurality of unit cells each of length a disposed in a stacked configuration extending in a depth direction by length, d, which in this implementation is generally perpendicular to a surface of the flow channel along which a fluid flows in the flow channel.

A single unit cell of the structural subsurface material structure, in this implementation comprises a first layer and a second layer of different Young's modulus, density and layer thickness disposed adjacent to each other. In one example implementation, for example, the first layer may include a polymer, such as ABS, and the second layer may include a metal material, such as aluminum. However, these are merely examples and other materials are contemplated.

In another implementation, a surface of a flow channel (e.g., the bottom surface shown in FIG. 1) includes a flexible material that may move in response to a pressure exerted on the surface by a fluid flowing in the flow channel. A one-dimensional (1D) subsurface material of the subsurface structure, such as an elastic periodic material with a periodicity extending along a depth of the material, is disposed outside a flexible surface of the flow channel. Movement of the flexible surface correspondingly causes movement in an interface surface of the subsurface material.

In this particular implementation, the flow channel comprises a plurality of walls, such as the four walls shown, and having a generally rectangular cross-section. In other implementations, the flow channel may comprise any shape such as having a generally circular, elliptical, square, polygon or other cross-section. The flow channel may also include varying dimensions, such as a narrowing or expanding flow channel.

In this example implementation, a flow direction of a fluid flowing through the flow channel flows in a first direction is shown by the arrow. The flow channel includes a plurality of surfaces defining the flow channel disposed within an inner boundary formed by the surfaces. In this implementation, at least one of the surfaces comprises a flexible surface that interacts with the one-dimensional (1D) elastic periodic material. In this implementation, the one-dimensional elastic periodic material includes a plurality of unit cells each of length a disposed in a stacked configuration extending in a depth direction, d, which in this implementation is generally perpendicular to a rigid surface of the flow channel along which a fluid flows in the flow channel.

As described herein, a structural subsurface includes either a subsurface structure material that extends into a flow channel and directly interacts with the flow or is disposed adjacent to a flexible flow surface that forms a portion of a flow channel.

A single unit cell of the structural subsurface material structure, in this implementation again comprises a first layer and a second layer of different Young's modulus, density and layer thickness disposed adjacent to each other. In one example implementation, for example, the first layer may include a polymer, such as ABS, and the second layer may include a metal material, such as aluminum. However, these are merely examples and other materials are contemplated.

In various embodiments, one or more subsurface structure elements may be used to control the overall structural compliance of a subsurface structure by selection of its material(s) and/or structural geometry and dimensions. In one embodiment, for example, a structural material may be distributed, such as but not limited to in a direction perpendicular to a flow surface, such that the overall structural compliance (opposite of stiffness) of the that structure results in a decrease in drag along the flow surface adjacent or juxtaposed to where the subsurface structure is applied. This effectively reduces negative effects of turbulence. Prior approaches place a thin “surface material” or a thin “coating” along the surface; these do not extend in a direction away from the flow surface (e.g., in the perpendicular direction from the flow surface) and therefore need to be overly compliant (i.e., like rubber) to reduce the drag. In embodiments provided herein, a subsurface material may comprise a relatively stiff material (like plastic) because the overall structural compliance need not be defined just by the type of material but by the fact that the subsurface material extends as a structure away from the flow surface. The longer the extension, the lower the stiffness (the higher the compliance) as felt by the flow. As described herein, the structural subsurface may comprise a number of different size, shape and location structural subsurface materials that may be adapted for different turbulent flow conditions.

In principle, the structure used to control the flow may be a standard homogenous and uniform elastic structure for which the performance metric will similarly be used to guide the design. One advantage of using a periodic material as a structural subsurface material in some implementations, however, is that it is based on intrinsic unit-cell properties and is thus more robust to any changes to the boundary conditions during operation.

In one implementation of a flow-related system, for example, one or more periodic material structures may be designed to control a transition of a fluid from a laminar flow to a turbulent flow. The transition from a laminar flow to a turbulent flow can be delayed by increasing the stability of the flow. Similarly, the transition of the laminar flow to a turbulent flow may be controlled to be earlier than would otherwise be achieved by decreasing the stability of the flow.

FIG. 2 shows a plurality of example configurations of periodic materials that may be used to form a structural subsurface material. However, it is important to note that periodic materials, such as phononic crystals, are merely one example of a type of material that may be used as a structural subsurface material as discussed above. In this particular example, the periodic materials are one-dimensional, two-dimensional or three-dimensional elastic periodic materials. Each of the elastic periodic materials also have a periodicity extending along the corresponding one-, two- or three dimensions of the crystal. In the one-dimensional example shown (also shown in FIG. 1), the periodicity of the periodic material (e.g., a phononic crystal) extends along the depth (first) dimension with reference to FIG. 1. The periodicity in the two-dimensional material example extends along two dimensions (e.g., length and width). In the three-dimensional example, the periodicity extends in three dimensions such as along x, y and z axes.

FIG. 2 also shows example types of periodicity that may exist in a structural subsurface material. In one example, the periodicity may be due to component materials of the structural subsurface material. In some examples, a unit cell includes two materials disposed adjacent to each other (e.g., polymer and metal such as ABS and aluminum) that together provide a periodicity that extends along one or more dimensions depending on the structural subsurface material structure being used. In another implementation, the periodicity may be due to a geometric design within one or more unit cells of the structural subsurface material structure. In the example shown in FIG. 2, for example, alternating layers having different lengths may provide for a periodicity extending along one or more dimensions depending on the structural subsurface material structure used. Similarly, a periodicity of a structural subsurface material structure may be provided by a boundary condition, such as periodic attachment to another medium. FIGS. 3 through 8 show further examples of periodic materials and mechanical metamaterials that may be used as structural subsurface materials as described in more detail herein.

In one example embodiment, a performance metric may be determined based on a stiffness or compliance of a structural subsurface material where the flow surface is in the range of relatively high stiffness, i.e., the flow surface does not exhibit relatively large finite deformation (as opposed to infinitesimal deformation or minor finite deformation) and effectively remains substantially straight and retains its shape in response to a passing flow of interest. In one particular implementation, for example, the deformation can be small such that the shape of the surface profile practically does not change in response to a flow, yet is compliant enough to permit the structural subsurface material to move in response to the flow. As discussed herein, the stiffness or compliance are inverse of each other, i.e., compliance=1/stiffness. As the structural compliance of the material increases (and the corresponding stiffness decreases), the performance of the structural subsurface material increases for a partially developed or fully developed turbulent flow.

The lower the effective stiffness (primarily in the direction perpendicular to the flow surface but also with variants/components in different directions as observed at the interface of the flow surface and the flow) of the structural subsurface material where the flow surface remains effectively substantially straight in response to a flow of interest, the better the performance of the structural subsurface material in reducing surface friction drag from turbulence of the flow. For the same structural subsurface material compared to a solid homogeneous structure of the same material, the deeper/longer (dimension extending at least substantially perpendicular to the flow) the dimension of the structural subsurface material, the lower the effective stiffness of the structural subsurface material, such as in a dimension perpendicular to the flow, and the better the performance of the structural subsurface material at reducing surface friction drag from the turbulence of the flow.

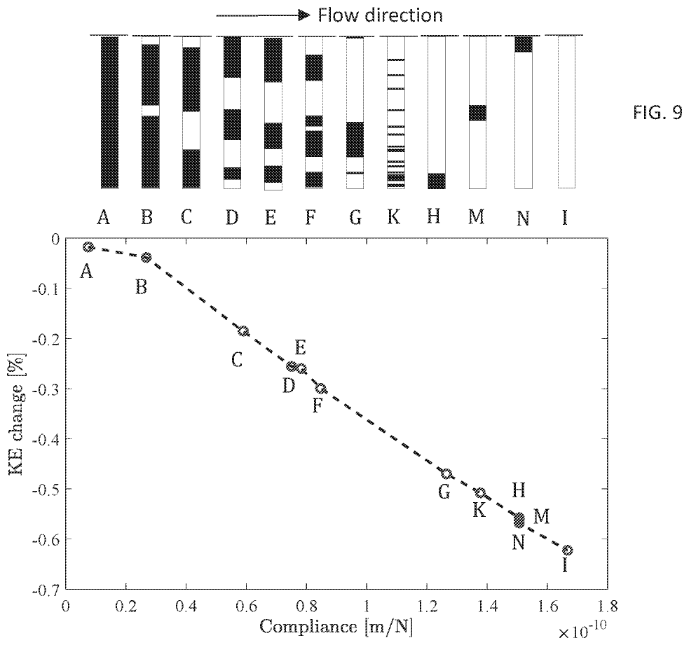

FIG. 9 is a graph showing kinetic energy change versus structural compliance of several example designs of a structural subsurface material as shown in FIG. 5 for a turbulent flow, where the structural compliance is calculated using the formula described above. This figure demonstrates that there is a correlation between the overall structural compliance of the structural surface and the degree of kinetic energy reduction in the turbulent flow. The larger the kinetic energy reduction in the turbulent flow, the lower the drag along the surface.

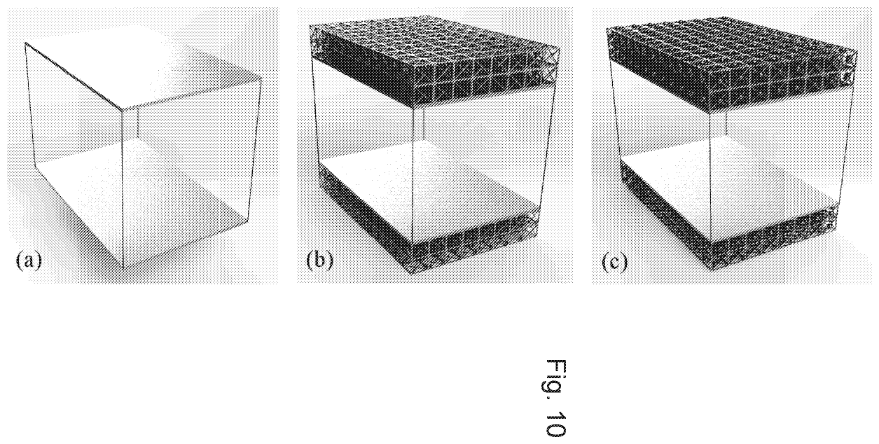

As shown in FIGS. 10 and 11, the structural subsurface material may further include one or more voids disposed within the structural subsurface material to further reduce the effective stiffness of the structural subsurface material (e.g., in a direction perpendicular to the flow/flow surface), and the better the performance of the structural subsurface material at reducing surface friction drag from the turbulence of the flow. Thus, the material may be designed to have a lower effective surface than a solid periodic material comprising the same material, and thus improve the performance of the structural subsurface material at reducing surface friction drag from the turbulence of the flow without increasing the depth of the structural subsurface material in the direction perpendicular to the flow.

Examples of materials that may be used in a structural subsurface material as described herein include polymers, epoxies, metals, composites, ceramics, or the like. Further, the structural subsurface material may be a solid homogeneous material, or an engineered or other designed variation of the material such as a lattice (e.g., having a network of rods and/or beams with voids disposed between them), a 3D printed material including a plurality of voids, or pores.

Further, the structural subsurface material itself may include a solid, non-voided surface that is disposed directly adjacent to the flow and/or be disposed adjacent to a solid flow surface that prevents the flow from extending into one or more voids of the structural subsurface material.

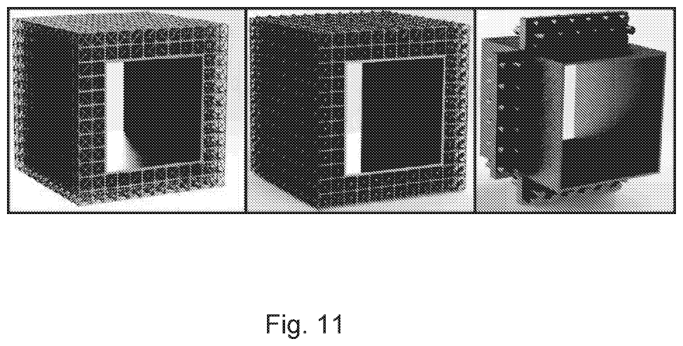

FIG. 12 is a graph showing kinetic energy change of a turbulent wave versus length, x. These results are for the layered structural subsurfaces shown in FIG. 5 and correspond to the results presented in FIG. 9 showing that the higher the overall compliance of the structural surface the stronger the reduction in the kinetic energy in the turbulent flow particularly near the area where the structural subsurface is applied.

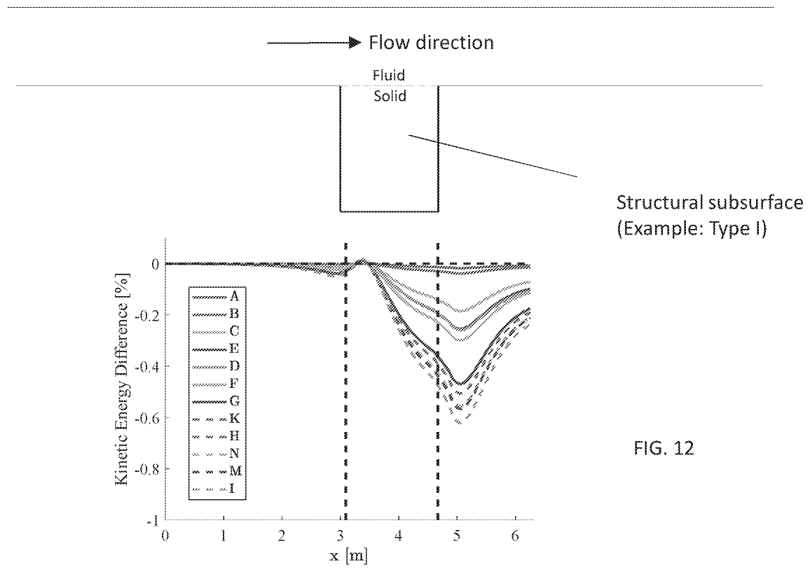

FIG. 13 shows side and top views of an example configuration of a structural subsurface material disposed adjacent to a flow. It can be seen in this example that the structural subsurface can be disposed in different locations along the surface and do not need to be contiguous.

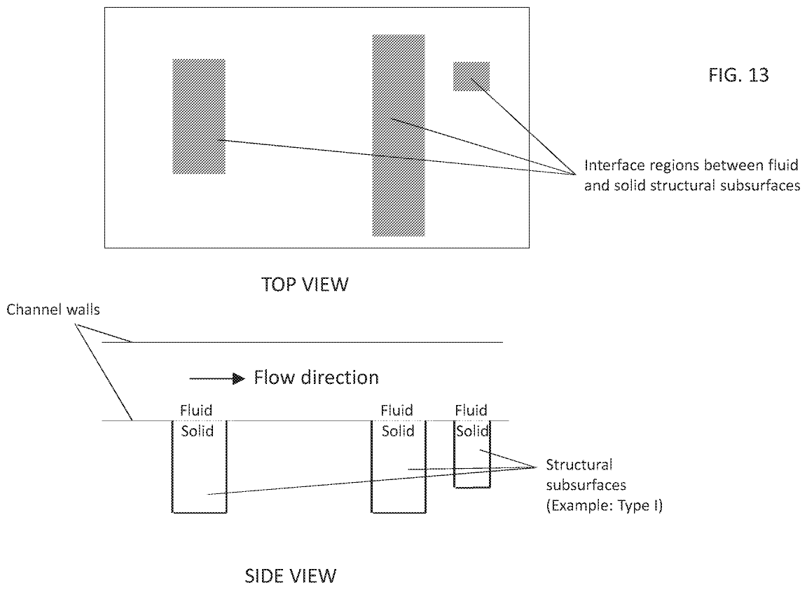

FIG. 14 shows side and top views of another example configuration of a structural subsurface material disposed adjacent to a flow. It can be seen in this example that the structural subsurface can be disposed in a manner with complete freedom in the size, location, and shape of the boundaries of the region where the structural subsurface is applied.

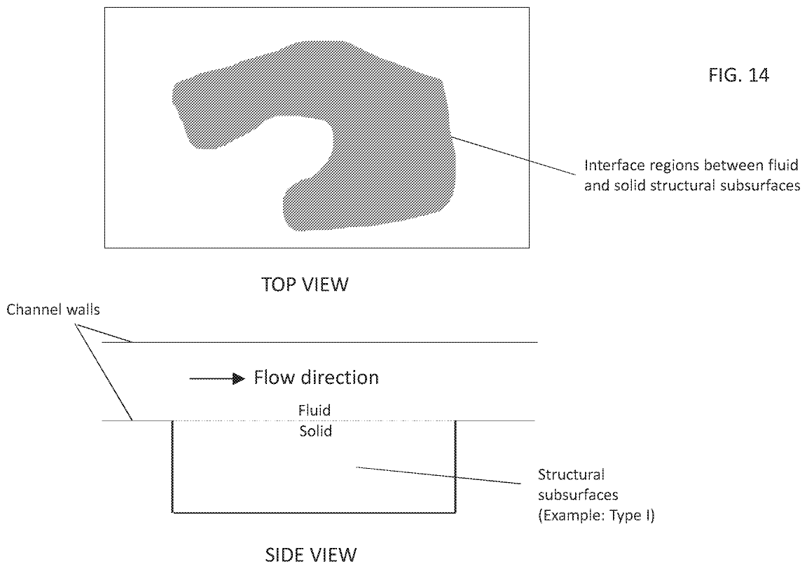

FIG. 15 is a schematic diagram of a distributed load applied to a sublattice designed to provide a desired effective structural compliance. The example sublattice shown may be attached to a flow (i.e., placed underneath the surface of a wing exposed to a flow) with a surface of the sublattice interfacing with the flow, either directly or through an intermediary layer. As described herein, a plurality of voids and members of the sublattice structure may be designed to provide the desired effective structural compliance of an overall subsurface structure. The distributed load is applied at the design stage to allow us to calculate the effective structural compliance of this sublattice. Our preliminary results have shown that the higher the effective structural compliance the more effective it is in reducing the intensity of turbulence and hence in reducing skin-friction drag.

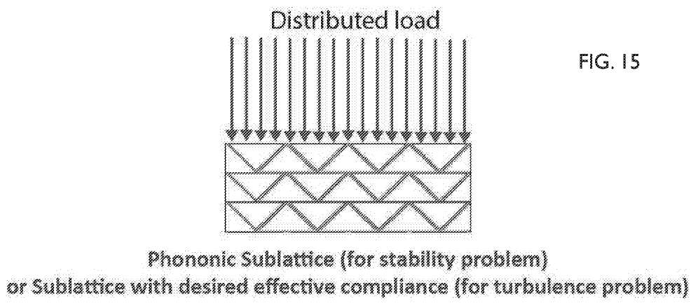

FIG. 16 is a schematic diagram of an example sublattice structure, such as shown in FIG. 15, disposed adjacent or juxtaposed to a flow. In this implementation, The example extended sublattice shown is being interfaced with a flow through a common interfacing surface. The effective structural compliance of this extended lattice structure, as measured along a vertical direction in this figure, is a key metric in determining the reduction in intensity of turbulence in the flow; higher effective structure compliance leads to lower the turbulence intensity, which leads to lower the skin-friction drag.

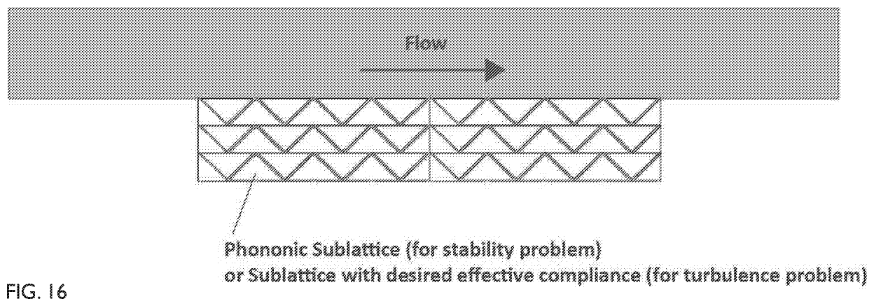

FIG. 17 is schematic diagram of another example sublattice structure, such as shown in FIGS. 15 and 16, disposed adjacent or juxtaposed to a flow. In this implementation, for example, the sublattice structure comprising a plurality of structural members and voids defined by the structural members of the sublattice structure is disposed between a pair of surfaces that may in some examples provide structural support to the sublattice structure. One of the pair of surfaces provides a flow surface disposed adjacent or juxtaposed to a flow and is adapted to interact with the flow as described herein. The example sublattice structure shown is being interface with a flow through a common interfacing surface. The effective structural compliance of the lattice structure, as measured along the vertical direction in this figure, is a key metric in determining the reduction in intensity of turbulence in the flow; higher effective structural compliance leads to lower turbulence intensity, which leads to lower skin-friction drag.

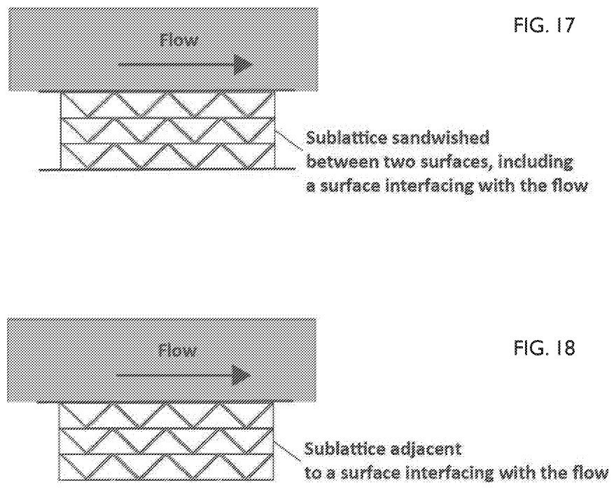

FIG. 18 is schematic diagram of another example sublattice structure, such as shown in FIGS. 15 and 16, disposed adjacent or juxtaposed to a flow. In this implementation, for example, the sublattice structure comprising a plurality of structural members and voids defined by the structural members of the sublattice structure is disposed under a surface that may in some examples provide structural support to the sublattice structure. This surface provides a flow surface disposed adjacent or juxtaposed to a flow and is adapted to interact with the flow as described herein. The example sublattice structure shown is being interfaced with a flow through a common interfacing surface. The effective structural compliance of this lattice structure, as measured along the vertical direction in this figure, is a key metric in determining the reduction in intensity of turbulence in the flow; higher effective structure compliance leads to lower turbulence intensity, which leads to lower skin-friction drag.

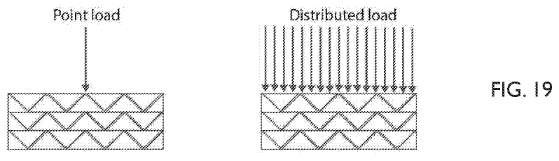

FIG. 19 includes schematic diagrams of a point load and a distributed load applied to a sublattice structure, such as those shown in FIGS. 15-18. As described herein, a plurality of voids and members of the sublattice structure may be designed to provide the desired effective structural compliance of an overall subsurface structure. Either a point load or a distributed load can be applied at the design stage to allow us to calculate the effective structural compliance of this sublattice. Our preliminary results have shown that the higher the effective structural compliance the more effective it is in reducing the intensity of turbulence and hence in reducing skin-friction drag.

In FIGS. 15-19, a triangular internal lattice geometry is used for all the examples provides. Alternatively, other internal lattice geometries may be used; examples include hexagonal honeycomb, triangular honeycomb Kagomé lattice, square honeycomb, among others (see Journal of the Acoustical Society of America, 119(4), April 2006 by Phani et al. for a formal definition of these internal lattice geometries.

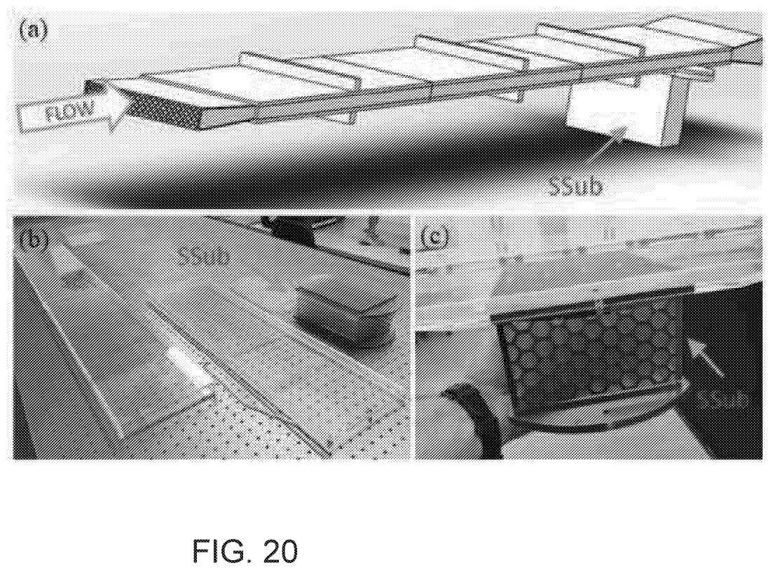

FIG. 20 is a schematic drawing showing a prototype turbulent channel rig that can be used for testing the performance of an example structural subsurface material such as the example lattice substructure (labeled here as SSub) shown for the purpose of turbulent flow increase or decrease in intensity of turbulence. FIG. 20 also shows examples of fabricated channel components of the channel rig, and a three-dimensional (3D) printed structural subsurface material labeled as SSub in FIG. 20. In this example, the lattice has a honeycomb internal geometry, although other internal geometries such as those described herein may alternatively be used in the turbulent channel rig.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A structural subsurface, comprising:
a flow interface surface adapted to be disposed adjacent to a turbulent flow; and
a subsurface feature comprising a structural material, the subsurface feature extending away from the flow interface surface;
wherein the subsurface feature alters an effective structural compliance of the flow interface surface relative to the turbulent flow such that the turbulent flow experiences an alteration in one or both of a surface skin-friction drag and a kinetic energy.

2. The structural subsurface of claim 1, wherein the alteration comprises a decrease in one or both of the surface skin-surface drag and the kinetic energy.

3. The structural subsurface of claim 1, wherein the alteration comprises an increase in one or both of the surface skin-surface drag and the kinetic energy.

4. The structural subsurface of claim 1, wherein the structural material forms the flow interface surface.

5. The structural subsurface of claim 1, wherein the structural material is disposed adjacent to the flow interface surface.

6. The structural subsurface of claim 1, wherein the flow interface surface comprises a surface of a flow channel.

7. (canceled)

8. The structural subsurface of claim 1, wherein the subsurface feature comprises one of: a structure that is periodic in one dimension, a structure that is periodic in two dimensions, and a structure that is periodic in three dimensions.

9-10. (canceled)

11. The structural subsurface of claim 1, wherein the subsurface material comprises a bulk material.

12. (canceled)

13. The structural subsurface of claim 1, wherein the flow interface has a relative compliance such that the flow interface surface deforms in response to the turbulent flow.

14. The structural subsurface of claim 1, wherein the subsurface feature reduces an effective structural compliance of the flow interface surface and the subsurface feature.

15. The structural subsurface of claim 1, wherein the subsurface feature extends in a direction perpendicular to the flow interface surface.

16. (canceled)

17. The structural subsurface of claim 1, wherein the subsurface feature extends in a direction perpendicular to a flow direction of the turbulent flow.

18. The structural subsurface of claim 1, wherein the subsurface feature extends in a direction that is not perpendicular to a flow direction of the turbulent flow.

19-21. (canceled)

22. A method of interacting with a turbulent flow, comprising:
exerting a pressure from the turbulent flow onto an interface surface, the pressure being associated with at least one wave having at least one frequency;
receiving the at least one wave with a subsurface structure extending away from the interface surface;
altering a phase of the at least one wave with the subsurface structure; and
vibrating the interface surface at a frequency, phase, and amplitude in response to the altered phase of the at least one wave;
wherein the subsurface structure alters an effective structural compliance of the flow interface surface relative to the turbulent flow such that the turbulent flow experiences an alteration in one or both of a surface skin-friction drag and a kinetic energy.

23. The method of claim 22, wherein the alteration comprises a decrease in one or both of the surface skin-surface drag and the kinetic energy.

24. The method of claim 22, wherein the alteration comprises an increase in one or both of the surface skin-surface drag and the kinetic energy.

25. The method of claim 22, wherein the subsurface structure forms the flow interface surface.

26. The method of claim 22, wherein the subsurface structure is disposed adjacent to the flow interface surface.

27. The method of claim 22, wherein the flow interface surface comprises a surface of a flow channel.

28. (canceled)
